(19) United States
(12) Patent Application Publication
(10) Pub. No.: US 2019/0230944 A1
(43) Pub. Date: Aug. 1, 2019

(54) PROCESS FOR MAKING AN EDIBLE MOIST SHREDDED SQID PRODUCT

(71) Applicant: SURF 82 SEAFOOD LLC, Wakefield, RI (US)

(72) Inventors: Neal NAITO, Elkridge, MD (US); Chong LEE, Wakefield, RI (US)

(21) Appl. No.: 16/332,152

(22) PCT Filed: Sep. 11, 2017
(86) PCT No.: PCT/US2017/050931

§ 371 Date: Mar. 11, 2019

Related U.S. Application Data
(60) Provisional application No. 62/385,360, filed on Sep. 9, 2016.

(51) Int. Cl. A22C 25/00; A23L 17/50; A23B 4/03; A23L 3/40

(52) U.S. Cl. CPC A22C 25/003; A23L 3/40; A23B 4/03; A23L 17/50

(57) ABSTRACT

Seafood products are made from squid by cleaning a squid by removing arms and tentacles from the squid; removing visceral content from the squid; steam cooking the squid; reducing the moisture content of the squid to between 40% by weight and 72% by weight; and shredding the squid after the step of reducing the moisture content. The shredded squid can be treated with marinades for flavor enhancement to create a variety of world cuisine tastes. The product is ready to serve without further cooking.

### BACKGROUND

### Field of the Invention

This invention relates generally to food manufacturing a packaged ready-to-serve moist shredded squid product.

### Description of Related Art

In many parts of the world, squid is widely used as a source of dietary protein. Presently, shredded squid is a dried, jerky-like, shredded, and seasoned, seafood product which is commonly found in coastal Asian countries, Russia, and Hawaii.

Presently, raw squid is cleaned with viscera, pen and skin removed, and the mantle is commonly cut into rings and strips (12-37 mm in width or length). The squid is then frozen, requiring cooking before eating. The most common form of squid in the United States is ‘calamari rings’, which are typically battered and/or breaded, fried, and served as an appetizer. In Asia, the cleaned raw squid is frequently seasoned and dried. The dried squid may be packed whole, or shredded after drying. The finished dry shredded squid products are shelf-stable, due to a low water activity and a moisture content of between about 15% and about 25%.

The related art of interest describes various methods of producing fish products, but none discloses the present invention. There is a need for making available “near fresh” ready-to-serve, moist, tender shredded squid to help address the growing interest in consuming seafood as an alternative to land-based meat products such as beef, poultry or pork. For example, the prior art describes a process for manufacturing reconstituted squid in the form of rings. The edible squid parts are washed and minced together at below zero temperatures. The pieces are compacted into ring-shaped molds. The rings are dipped into batter or bread crumbs and frozen. The resulting product is typically fried, resulting in a food item which is high in fat.

Additional prior art processes describe the preparation of ring-shaped cuttlefish pieces by kneading the arms and fins with salt to obtain a meat paste, mixing the paste with seasoned, chopped, and cooked squid, and punching into the resulting mixture into rings. Other prior art processes involve roasting the squid.

The prior art also describes a production process for steamed squid. The process includes sterilizing and heating a squid containing 20% moisture. The selected squid is vacuum-packed, steamed and sterilized after soaking it in a boiling water of 98° C.

However, conventional processes for producing shredded squid produce a product containing less than 25% moisture, which has a texture similar to that of meat jerky. While jerky is popular as a snack food, shredded squid does not lend itself to preparation of meals with a variety of tastes and textures. With the increasing popularity of the substitution of seafood for meat in popular recipes, including tacos, burritos, salads, and meat patties suitable for use in sandwiches, there is a need for a seafood product that is ready to serve right out of the package. Ideally, this seafood product should require no cooking/frying be less expensive than shrimp and salmon, but approximate the taste and texture of fresh seafood.

### SUMMARY

In light of the present need for a palatable shredded squid product having a moist, tender texture, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments disclosed herein relate to a shredded squid product having a high moisture content, which is sufficiently tasty, moist, and tender to be used in preparation of a variety of food products, both at home or in a food service setting.

Various embodiments relate to a process for making a shredded squid product, comprising:
a. cleaning a squid by removing the arms and tentacles from the squid, and removing visceral content from the squid;
b. steam cooking;
c. reducing the moisture content of the squid; and
d. shredding the squid after the step of reducing the moisture content.

In some embodiment, the step of reducing the moisture content of the squid includes a step of short duration heated air drying.

In the process for making a moist shredded squid product, the squid may be a squid of the Illex genus, but is not limited to this genus. In various embodiments, the size of the squid is a ranges from 9 centimeters to 40 centimeters in the fin-mantle length. The squid normally has an initial moisture content of greater than 75% by weight, or between 77% and 82% by weight.

Various embodiments disclosed herein relate to a process for making a moist shredded squid product, with a first step of cleaning a squid by removing the arms and tentacles from the squid, and removing visceral content from the squid. In a second step, the squid is steam cooked. In a third step, the squid is partially dried, with reduction of the moisture content to between 40% by weight and 72% by weight water, between 40% and 66% by weight water, between 50% by weight and 72% by weight water, between 60% by weight and 70% by weight water, between 65% by weight and 70% by weight water, or about 66% by weight water. In a fourth step, the partially dried squid is shredded.

In various embodiments disclosed herein, the step of cooking the squid comprises steaming the squid for between 1 and 10 minutes, between 2 and 8 minutes, or between 3 and 6 minutes. The steaming may be carried out at a temperature of between 80° C. and 121° C.; between 80° C. and 110° C.; or between 80° C. and 100° C. The steaming may be carried out under prevailing atmospheric pressure, at an elevated pressure of up to 15 psi above sea level pressure, or from 11.6 to 15 psi above sea level pressure. The steaming may be carried out at reduced pressure, thereby allowing steaming at a temperature of less than 100° C. In certain embodiments, the step of partially drying the squid comprises steaming the cleaned squid for between 3 and 6 minutes at between 80° C. and 100° C. under atmospheric pressure.

In certain embodiments, the step of partially drying the squid comprises a step of steaming the squid for between 1 and 10 minutes, between 2 and 8 minutes, or between 3 and 6 minutes; and then partially drying the steamed squid with heated air at a temperature of between 60° C. and 90° C., between 70° C. and 90° C., between 60° C. and 80° C., or between 75° C. and 85° C. The step of partially drying the steamed squid with heated air may be carried out for between 10 and 30 minutes. The partially dried squid is then shredded. Optionally, the shredded squid may be seasoned with various marinades, depending upon the type of product intended.

In various embodiments disclosed herein, the shredded squid is vacuum packed. The shelf life of the vacuum-packed squid may be extended by steam heating the vacuum packed squid at between 90° C. and 110° C.; irradiating the vacuum packed squid with ionizing radiation; subjecting the vacuum packed squid to a high level of isostatic pressure (high pressure processing); or a combination thereof.

Various embodiments disclosed herein relate to food products comprising a shredded squid product produced by processes of reducing the moisture content of the squid to between 40% and 72% by weight; and then shredding the squid. These food products may be used in recipes that require moist, tender, shredded squid meat. Potential recipe applications include, but are not limited to, seafood salads, wraps, tacos or burritos, soups, ramen, seafood cakes, burgers, gyros, and various Asian cuisines.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation that may be apparent to those skilled in the art. Accordingly, the present invention resides in the novel methods, arrangements, combinations, and improvements herein shown and described in various exemplary embodiments.

### BRIEF DESCRIPTION OF THE DRAWINGS

In order to better understand various exemplary embodiments, reference is made to the accompanying figure, wherein:

FIG. 1 shows electrophoresis of proteins from raw squid, conventional dried shredded squid, and steamed squid as disclosed herein, compared to a standard comprising a mixture of peptides of known molecular weight; and

FIG. 2 shows a comparison of the texture of squid prepared as described in the current disclosure and commercial dried squid.

### DETAILED DESCRIPTION OF PREFERRED EMBODIMENTS

Various embodiments disclosed herein relate to squid products which can be stored in a variety of formats. In particular, the squid products may be refrigerated, frozen, or vacuum packaged. The squid products may be used in a wide range of cuisines, including, but not limited to, Asian and European cuisines. As discussed above, conventional dried shredded squid products are dry, with a moisture content of less than 25% moisture. These products have a tough, chewy texture, similar to that of meat jerky.

Various embodiments disclosed herein relate to a moist, minimally seasoned, squid product. The squid product has greater than 40% moisture, and less than 72% moisture. Standard retail fresh squid is composed of 77-80% of water by body weight, which makes fine shredding difficult or impossible.

In some embodiments, the squid product has a moisture content of between 40% by weight and 72% by weight of water, between 50% by weight and 72% by weight of water, between 60% by weight and 70% by weight of water, between 65% by weight and 70% by weight of water, or about 66% by weight of water. In a third step, the partially dried squid is shredded. For some food products requiring squid, the squid product has a moisture content of between 66% by weight and 72% by weight of water, producing a palatable squid product with a tender, moist, slightly firm texture. This product may be substituted for fresh squid, fish, or other seafood in most recipes, and is suitable for the ready-to-serve food market in both the retail and food service.

Additionally, drying steam cooked squid to a moisture content of between 40 and 66%, between 45 and 62%, between 50 and 60%, or between 55 and 60% is anticipated in order to make squid products having a desired moisture content, coupled with a firmer texture. Such products may be used in preparing processed foods such as calamari sausage, which require a firmer texture.

By using small squid, and modestly steam cooking and drying them after cleaning, the resultant squid meat becomes amenable to fine, uniform shredding. In various embodiments, suitable small squid are squid of the Illex genus. In some embodiments, suitable small squid have a fin-mantle length of from 15 centimeters to 25 centimeters or 9 to 40 centimeters.

The present disclosure is directed to development of a process for the production of moist, tender “near fresh” shredded squid to be used in various convenience food applications such as tacos, burritos, ramen, seafood pancake, seafood salad, etc. for the ready-to-serve retail and food service markets. In various embodiments, a raw Rhode Island caught Illex squid (northern shortfin squid, Illex illecebrosus) is used. The squid, with a mantle which may be about 15 cm to 25 cm in length or 9 cm to 40 cm in length, is processed using a series of steps. These steps include cleaning, cooking the squid in a manner which retains moisture in the meat, partially drying the cooked squid, and shredding the cooked squid. Steam cooking is the preferred method of cooking, as it retains flavor and texture better than methods involving direct contact with water, e.g., boiling or blanching.

Cleaning the squid involves a first step of removing arms and tentacles from the squid by cutting the squid below the eyes. The arms and tentacles may be put aside for later use. Next, the squid mantle is split open longitudinally to expose the visceral content and pen. The visceral content and the pen are removed from the squid mantle by scraping it off the inner mantle. The cleaned squid mantle is rinsed to remove any visceral residues. The term “squid mantle,” as used herein, refers to either the mantle alone, or the squid mantle in combination with all or part of the fin of the squid.

The cleaned squid mantle is then cooked using a method which retains moisture in the meat. Suitable methods include steam cooking, immersion in boiling water, or brief microwaving, forced heat, poaching, simmering, broiling, roasting, grilling, baking, sauteing, pan-frying, or deep-fat frying.

Various embodiments disclosed herein involve a step of cooking using steam cooking. Preferably, steam cooking is carried out for between 3 and 6 minutes at 80-100° C. under atmospheric pressure. Steam cooking can be achieved in either a batch fashion or a continuous fashion. In a batch process, squid mantles are laid flat on steam racks, which are placed in a steamer and steamed for a specified duration. In a continuous process, the squid mantles are laid on steam racks, which are passed through a steam tunnel at a defined rate. The defined rate is sufficient to allow each squid mantle to be steamed for a specified duration.

The squid meat, as further described herein, is packaged prior to selling the squid meat. By briefly steaming the squid meat prior to packaging, the squid meat will not require any cooking to eat out of the package. However, the squid meat may be heated if desired, without any discernible degradation in sensory quality.

After steam cooking, the squid mantle is partially dried to reduce the moisture to greater than 40%, but less than 72%. This is done by drying with heated air at a temperature of between 60° C. and 90° C., for between 10 and 30 minutes. The drying increases the firmness of the meat texture, facilitating shredding or other processing. However, since the meat contains a significant amount of water after drying, i.e., greater than 40% water, the dried meat is firm, but does not adopt a chewy, jerky-like, texture. The step of partially drying the squid meat improves the overall sensory aspect of the squid meat, as it appears firmer, with better mouth feel and reduced odor. The drying process also improves the shelf life of the product when refrigerated due to the decreased moisture content.

In the next step, the partially dried meat is shredded using a mechanical shredder. The shredded meat is then seasoned, and packaged under vacuum. The packaged squid meat is pasteurized by steam heating, prior to refrigeration or freezing.

The step of shredding the squid meat involves cutting the squid mantle into strips which are from 0.5 mm to 4 mm wide. The strips may be from 9 cm to 20 cm in length. If the squid mantle does not include the fin, the strips may be from 9 cm to 12 cm in length. If the squid mantle also includes the fin, the strips may be from 14 cm to 20 cm in length. Smaller strips from 0.5 cm to near 9 cm can be created with further shredding. The strips are cut by either a right angle or a slant angle cut, using a mechanical shredder. Shredding is done by cutting cooked and partially dried flat mantles into narrow strips in a continuous fashion. Typical squid rings, in contrast, are produced by cutting uncooked raw tubes transversely in a specified width (1-2 cm). Shredding the meat to produce strips which are 1 to 4 mm wide softens the texture of the squid meat. Shredding by either a right angle cut or a slant angle cut provides different shapes and texture to the meat. Very narrow strips of squid meat, e.g., strips with a width of 0.5 mm to 1 mm, may be made to prepare a meat product which resembles noodles.

If the squid mantle is partially dried to a moisture content of between about 40% and about 65% by weight of water, or between 50% and 60% by weight of water, the squid mantle may be processed to produce a ground squid meat product. The ground squid meat product may be used to prepare meat patties. The ground squid meat product may also be used to prepare a ground squid crumble, or added to sauces or casseroles.

Alternatively, partially dried squid meat may be diced, cubed, or otherwise cut into individual shaped pieces. The partially dried squid mantle may be cut lengthwise into strips, and then the strips may be cut crosswise perpendicularly to the axis of the strip, or diagonally to the axis of the strip, producing small squid pieces. The partially dried squid mantle may also be cut into shaped pieces using a tool similar to a cookie cutter or a cookie cutting sheet. Such devices have shaped blades with a cutting edge which penetrates the squid meat, where the shaped blade forms a closed loop. The tool may cut the squid meat into circular, semicircular, square, or polygonal pieces.

The shredded, diced, or cubed squid meat is then seasoned. Seasoning is done with a marinade. In some embodiments, the marinade contains lemon juice (100 ml), sugar (10-20 g), rice vinegar (10-20 ml), and salt (2-5 g). In other embodiments, the marinade contains sugar, salt and components which lend an umami flavor to the marinade. The components lending an umami flavor may be umami flavor enhancers, including, but not limited to, MSG and L-glutamate. Smoke flavorings such as hickory, applewood, among others can also be used. Other flavorings and seasonings can be used to create products suitable for world cuisine such as Asian, European, South American, Indian, Africa, or Middle Eastern cuisines.

After seasoning, the shredded squid meat can be vacuum packed. The packaged squid meat is pasteurized by steam heating for between 5 and 10 minutes at 90° C. to 110° C. The pasteurizing step provides extended shelf life when the packaged squid meat is refrigerated or frozen. Other forms of food preservation such as freezing, high pressure processing (HPP), or irradiation of the packaged meat can be used. HPP is a cold pasteurization technique by which products, already sealed in their final package, are introduced into a vessel and subjected to a high level of isostatic pressure (300-600 MPa/43,500-87,000 psi), transmitted by water. These pressures inactivate the vegetative flora (bacteria, virus, yeasts, moulds and parasites) present in food, extending the product's shelf life and improving food safety. Irradiation may also be used to reduce pathogens in packaged food, reducing or eliminating the risk of food borne illnesses.

Alternatively, the shredded squid product may be canned. The shredded squid may be treated with cold water salt containing for 15 minutes the squid to increase the firmness of the flesh. The squid is then drained, and added to canning jars. A flavored liquid, such as tomato juice or a mixture of lemon juice and water, may be added to the canned squid.

### Example 1. Moisture Content of Squid Products

In this example, a Rhode Island caught Illex squid (northern shortfin squid, Illex illecebrosus) is processed by processes described in this application. Specifically, the squid is cleaned and steam cooked for between 3 and 6 minutes at 80-100° C. under atmospheric pressure. After cooking, the squid mantle is partially dried to reduce the moisture content to about 60% to about 72% by weight. The partially dried meat is shredded using a mechanical shredder. The shredded squid meat is then seasoned. Seasoning is done with either a lemon juice marinade containing lemon juice, sugar, rice vinegar, and salt to produce lemon-flavored squid, or with a marinade containing sugar, salt and umami flavor enhancer to produce an Asian flavored squid. The composition of the raw squid and the processed squid products was determined, and is reported in Table 1 below.

TABLE 1
Proximate composition of Illex squid mantle (%)

| | Moisture | Solids | Protein | Lipid |
|---|---|---|---|---|
| Raw squid | 79.40 ± 0.31 | 20.6 | 17.30 ± 1.51 | 1.50 ± 0.14 |
| Shredded Asian | 70.99 ± 0.72 | 29.01 | 24.03 ± 0.82 | 1.84 ± 0.14 |
| flavor | | | | |
| Shredded lemon | 70.81 ± 0.28 | 29.19 | 24.16 ± 0.42 | 2.41 ± 0.28* |
| flavor | | | | |

*The higher lipid content of the lemon flavored squid is due to lemon oil.

### Example 2. Texture of Squid Products

In this example, a Rhode Island caught Illex squid (northern shortfin squid, Illex illecebrosus), a squid of the genus Loligo (a squid having a mantle up to 40 cm long), and an Argentine-caught Illex squid (Illex argentinus, the Argentine shortfin squid; mantle length up to 33 cm) were cleaned and cooked.

The northern shortfin squid, the Argentine shortfin squid, and the Loligo squid were processed by processes described in this application. Specifically, the squid were cleaned and steam cooked for between 3 and 6 minutes at 80-100° C. under atmospheric pressure. After cooking, the squid mantle is partially dried to reduce the moisture to about 70% to about 72%. As seen in Table 2, steamed northern shortfin squid and steamed Loligo squid are tender, with a transverse cut force of ˜3.2 N and a longitudinal cut force of between 2 and 2.25 N. Steamed Argentine shortfin squid, in contrast, is tougher, with a transverse cut force of 7.7 N and a longitudinal cut force of 6.2 N.

Next, the northern shortfin squid was cleaned, and the mantle was boiled. After boiling, the squid mantle was partially dried to reduce the moisture to about 70% to about 72%. As seen in Table 2, boiled northern shortfin squid nearly as tender as steamed northern shortfin squid, with a transverse cut force of 3.73 N and a longitudinal cut force of 2.36 N.

TABLE 2
Texture analysis of squid mantles

| | Illex | Illex | | Illex |
|---|---|---|---|---|
| | illecebrosus | illecebrosus | Loligo | argentinus |
| | steamed | boiled | steamed | steamed |
| Transverse | 3.20 ± 0.7 | 3.73 ± 0.42 | 3.16 ± 0.40 | 7.70 ± 0.56 |
| cut force (N) | | | | |
| Longitudinal | 2.06 ± 0.41 | 2.36 ± 0.21 | 2.23 ± 0.38 | 6.20 ± 0.28 |
| cut force (N) | | | | |

*Values are the average of five measurements (n = 5) at 50% deformation using an Instron testing machine with a 1 mm flat blade.
N: Newton (unit of force).

Next, a sensory evaluation of the processed squid meat of Table 2 was conducted, using a panel of 5 evaluators who are familiar with squid texture. The sensory scores were based on a 1-9 point intensity scale, focusing on chewiness and rubberiness of the product. A score of 1 indicates very little chewiness or rubberiness; a score of 5 indicates moderate chewiness or rubberiness; and a score of 10 indicates intense chewiness or rubberiness. As seen in Table 3, steamed northern shortfin squid has the lowest degree of both chewiness and rubberiness, with boiled northern shortfin squid having moderately increased chewiness and rubberiness. Chewiness and rubberiness of the steamed Loligo squid falls between that of steamed northern shortfin squid and boiled northern shortfin squid. It is noted, however, that the error in these results is sufficiently large that it is not clear that the sensory differences among these products is significant.

Chewiness and rubberiness of the steamed Argentine shortfin squid is, however, significantly higher than that of steamed northern shortfin squid, as seen in Table 3. This result, together with the high cut force required for steamed Argentine shortfin squid when compared to cut force of steamed northern shortfin squid or Loligo squid, makes the Argentine shortfin squid a less preferred squid species for use in the process described herein.

TABLE 3
Sensory analysis of squid mantles

| | Illex | Illex | Loligo | Illex |
|---|---|---|---|---|
| | illecebrosus | illecebrosus | pealeii | argentinus |
| | steamed | boiled | steamed | steamed |
| Chewiness | 5.12 ± 1.12 | 7.23 ± 1.30 | 6.03 ± 1.21 | 8.23 ± 1.87 |
| Rubberiness | 6.23 ± 1.34 | 7.53 ± 1.17 | 7.02 ± 0.82 | 7.17 ± 1.33 |

### Example 3. Protein Profile of Squid Products

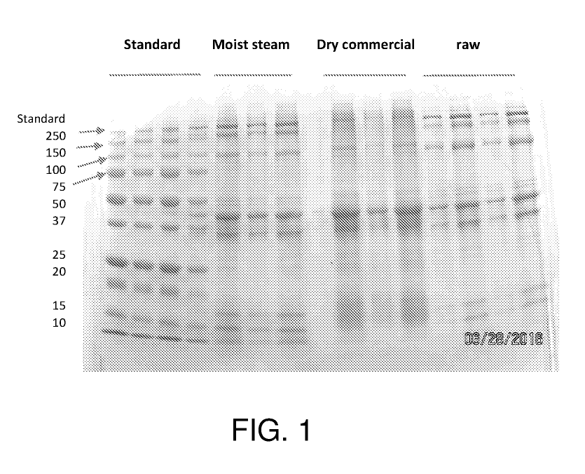

In this example, the protein pattern of Rhode Island caught Illex squid was characterized. To provide a sample of a squid product as disclosed herein, a Rhode Island caught Illex squid mantle was steam cooked for between 3 and 6 minutes at between 80-100° C. under atmospheric pressure. As a first comparative sample, raw Rhode Island caught Illex squid mantle was used. As a second comparative sample, commercially available dried shredded squid was used. The protein profile was characterized in a medium containing sodium dodecyl sulfate by polyacrylamide gel electrophoresis (SDS-PAGE), shown in FIG. 1.

The protein profile of the various squid products was characterized employing SDS-PAGE at a protein concentration of 2 mg/ml protein, in a pH 6 medium containing 1% SDS, 10% glycerol, 10 mM tris(hydroxymethyl)aminomethane hydrochloride, pH 6.8, 1 mM ethylene diamine tetraacetic acid (EDTA), and dithiothreitol (DTT) or 2-mercaptoethanol as a reducing agent.

The sodium dodecyl sulfate-polyacrylamide gel electrophoresis (SDS-PAGE) presents protein and peptide profiles in the proteinaceous materials. The accompanying figure shows the electrophoretic profiles of raw, steam-cooked and commercial shredded dry squid.

The raw squid and the steam-cooked Ilex squid mantle tissue maintained similar peptide profiles as raw sample, except for:

the protein having a molecular weight of 100 kD, which appears to be slightly degraded; and

the content of low molecular weight proteins, as the raw squid has two polypeptide bands corresponding to molecular weight of between 10 and 20 kD and the steamed squid has three polypeptide bands between 10 and 20 kD.

On the other hand, in the commercial dried squid product:

polypeptide bands having a molecular weight of 250-150 kD bands are degraded or polymerized, when compared to either raw or steamed squid;

the protein having a molecular weight of 100 kD is degraded to a much greater extent greater extent than the steam-cooked sample;

polypeptide bands having a molecular weight of 37-43 kD range are thicker and less defined than the corresponding bands from either raw or steamed squid; and

polypeptide bands having a molecular weight of 17-15 kD are very broad and poorly defined, when compared to the corresponding bands from either raw or steamed squid. Such changes in the electrophoretic profile of the commercial shredded dry squid can be attributed to severe protein degradration, resulting from extensive heating during the drying process, coupled with heavy use of sugar and salt during the course of manufacturing the dried, shredded squid.

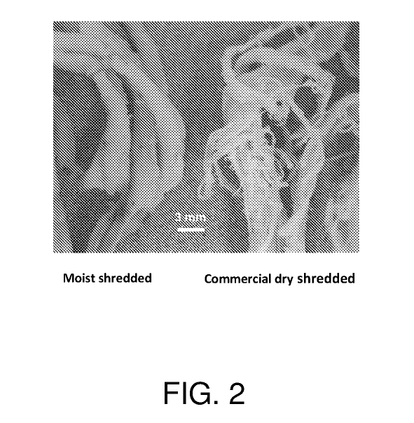

A clear structural difference is visible between the moist shredded and commercial dry shredded squid products, as seen in FIG. 2. The moist, shredded squid maintained the structural integrity and color of the raw squid, while the dried shredded squid has a dry, filamentous structure, and discoloration resulting from extensive heating and drying with heavy addition of sugar and salt.

Although various embodiments have been described in detail with particular reference to certain aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

1. A process for making a squid product, comprising:
a. cleaning a squid by removing arms and tentacles from the squid, and removing visceral content from the squid; and
b. either:
reducing the moisture content of the squid to between 40% by weight and 72% by weight; and, after the step of reducing the moisture content, shredding the squid; or
reducing the moisture content of the squid to between 40% by weight and 65% by weight and, after the step of reducing the moisture content, processing the squid to produce ground squid meat.

2. The process of claim 1, wherein the squid is a squid of the Illex genus or a squid of the Loligo genus.

3. The process of claim 1, wherein the squid has a mantle length of from 9 centimeters to 40 centimeters.

4. The process of claim 1, wherein the squid has an initial moisture content of between 77% and 82%.

5. The process of claim 4, wherein step (b) comprises reducing the moisture content of the squid to between 50% by weight and 70% by weight; and shredding the squid.

6. The process of claim 4, wherein step (b) comprises reducing the moisture content of the squid to between 60% by weight and 70% by weight; and shredding the squid.

7. The process of claim 1, wherein step (b) comprises steaming the cleaned squid for between 3 and 6 minutes at between 80° C. and 100° C.

8. The process of claim 1, wherein step (b) comprises steaming the cleaned squid for between 3 and 6 minutes at between 80° C. and 100° C. under atmospheric pressure.

9. The process of claim 1, wherein step (b) comprises:
i. steaming the cleaned squid for between 3 and 6 minutes; and
ii. partially drying the steamed squid with heated air at between 60° C. and 90° C. for from 10 to 30 minutes.

10. The process of claim 13, further comprising seasoning the shredded squid with a marinade.

11. The process of claim 13, further comprising vacuum packing the shredded squid.

12. The process of claim 11, further comprising a step for extending a shelf life of the vacuum packed squid, said step for extending the shelf life comprising:
steam heating the vacuum packed squid at between 90° C. and 110° C.;
irradiating the vacuum packed squid with ionizing radiation;
subjecting the vacuum packed squid to a high level of isostatic pressure;
or a combination thereof.

13. A food product comprising a shredded squid product produced by the process of claim 1.

14. The process of claim 1, wherein step (b) comprises shredding the squid after reducing the moisture content.

15. The process of claim 1, wherein the moisture content of the squid is reduced to between 40% by weight and 65% by weight.

16. The process of claim 15, wherein the squid is processed after reducing the moisture content to produce ground squid meat.

17. The process of claim 16, further comprising:
c. preparing meat patties from the ground squid meat.

18. The process of claim 1, further comprising:
c. preparing a food product from the squid after step (b);
said food product being selected from the group consisting of seafood salads, seafood wraps, seafood tacos, seafood burritos, soups, ramen, seafood cakes, seafood burgers, gyros, and calamari sausage.

19. The process of claim 1, wherein said food product is a seafood cake.

20. The process of claim 1, wherein reducing the moisture content of the squid comprises immersion in boiling water, brief microwaving, forced heat cooking, poaching, simmering, broiling, roasting, grilling, baking, sauteing, pan-frying, or deep-fat frying.
